(19) United States
(12) Patent Application Publication
(10) Pub. No.: US 2005/0110870 A1
(43) Pub. Date: May 26, 2005

(54) System and method for object tracking path generation

(76) Inventors: Gia-Hung Tsai, Sanchong City (TW); Chih-Chun Lai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/814,215

(22) Filed: Mar. 31, 2004

(30) Foreign Application Priority Data
Nov. 25, 2003 (TW) 92133009

(51) Int. Cl. H04N 7/12

(52) U.S. Cl. 348/169; 375/240.01

(57) ABSTRACT

A system and method for object tracking path generation. The system includes a digital media player having a player interface to play a digital media file, and a tracking path processing unit. The tracking path processing unit defines and records position data of an object in frames of the digital media file on the player interface during playback. The tracking path processing unit records time data of the frames, and generates an object tracking path of the object in the digital media file according to the position and time data. Additionally, the tracking path processing unit adjusts the object tracking path when the digital media file and the object tracking path are simultaneously played in the player interface, and transforms the object tracking path to a specific format according to the position and time data.

### BACKGROUND OF THE INVENTION

1. Field of the Invention

The present invention relates to a system and method for object tracking path generation, and particularly to a system and method that integrates with a digital media player for automatically generating object tracking paths of objects in the digital media file, and simultaneously adjusting the object tracking paths during playback.

2. Description of the Related Art

With the development of information technology, digital content has become a subject of interest to users and developers alike. Digital content may include sounds, images, and 2D (dimensional)/3D (dimensional) objects. The digital content may also be designed to be interactive.

For example, MPEG (Motion Picture Experts Group) defines the MPEG-4 standard for video data is capable of integrating various forms of data and interactive objects. In the video verification model of MPEG-4, a frame of a digital media file may be composed of several video objects, such that the digital media file can be interactive. In practice, users can interact with a scene, for example, to change user and/or object positions in the scene, generate events to trigger specific objects, and select specific language modes.

Prior to designing digital content for user interaction, the object information including object shapes and positions at different points in time must be determined. The object information is then manually transformed to a specific format, such as binary format for scene (BIFS) to represent corresponding object tracking paths. There is however, no effective mechanism for generating object tracking paths. Conventionally, object tracking paths are generated by repeatedly watching the digital media file, and recording the object data therein. This, however, is time-consuming and the recorded object information may be inaccurate. Additionally, the object shape is user-determined, thereby increasing operational difficulty.

### SUMMARY OF THE INVENTION

It is therefore an object of the present invention to provide a system and method that integrates with a digital media player, and automatically generates object tracking paths of objects in the digital media file.

Another object of the present invention to provide a system and method that automatically determines object shapes.

It is further an object of the present invention to provide a system and method that simultaneously adjusts the object tracking paths during playback of the digital media file.

It is still an object of the present invention to provide a system and method that automatically transforms the object tracking paths to a specific format.

To achieve the above objects, the present invention provides a system for object tracking path generation. The system comprises a digital media player having a player interface to play a digital media file, and a tracking path processing unit. The tracking path processing unit has a position definition module and a path recording/generation module. The position definition module defines position data of an object in at least a first frame and a second frame of the digital media file via the player interface during the playback of the digital media file. The path recording/generation module records the position data defined by the position definition module, and time data of the first and second frames, and generates an object tracking path of the object in the digital media file according to the position and time data.

The tracking path processing unit further includes a frame interval definition module for defining a frame number between a predetermined first and second frame. During playback, the predetermined first and second frames are played. Alternatively, the entire digital media file is played, and then playback is suspended at the predetermined first and second frames when the first and second frames are played.

The tracking path processing unit further includes a shape determination module to determine shape data of the object in the first and second frames, and the path recording/generation module further records the shape data and integrates it to the object tracking path.

The tracking path processing unit further includes a path adjustment module to adjust the object tracking path when the digital media file and the object tracking path play simultaneously in the player interface, and the path recording/generation module further records the adjusted object tracking path.

The tracking path processing unit further includes a transformation module to transform the object tracking path to a specific format according to the position, time and shape data.

According to another embodiment of the invention, a method for object tracking path generation is provided. First, a digital media file is played in a digital media player having a player interface. Then, position data of an object in at least a first frame and a second frame of the digital media file is defined via the player interface during playback, and the position data and time data of the first and second frames is recorded. Thereafter, an object tracking path of the object in the digital media file is generated according to the position and time data.

Further, a frame number between the first and second frames is defined. During playback, the predetermined first and second frames are played. Alternatively, the entire digital media file is played, and then playback is suspended at the predetermined first and second frames when the first and second frames are played.

Further, shape data of the object in the first and second frames is determined, recorded, and integrated to the object tracking path. The object tracking path is further adjusted when the digital media file and the object tracking path play simultaneously in the player interface, and the adjusted object tracking path is recorded. Further, the object tracking path is transformed to a specific format according to the position, time and shape data.

The above-mentioned method may take the form of program code embodied in tangible media. When the program code is loaded into and executed by a machine, the machine becomes an apparatus for practicing the invention.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating the architecture of the system for object tracking path generation according to the present invention;

FIG. 2 is a flowchart showing the method for object tracking path generation according to the present invention;

FIG. 3 is a flowchart showing the method for object tracking path adjustment and transformation according to the present invention; and

FIG. 4 is a schematic diagram illustrating a storage medium for storing a computer program for execution of the method for object tracking path generation according to the present invention.

### DETAILED DESCRIPTION OF THE INVENTION

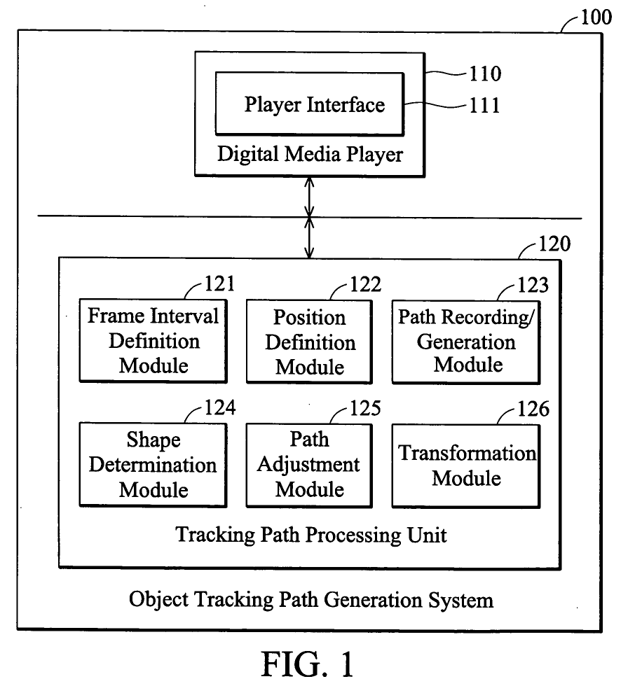

FIG. 1 illustrates the architecture of the system for object tracking path generation according to the present invention.

As shown in FIG. 1, the object tracking path generation system 100 includes a digital media player 110 and a tracking path processing unit 120. The digital media player 110 has a player interface 111 to play a digital media file, in which the digital media file includes a plurality of frames. The tracking path processing unit 120 includes a frame interval definition module 121, a position definition module 122, a path recording/generation module 123, a shape determination module 124, a path adjustment module 125 and a transformation module 126.

The interval definition module 121 defines a frame interval having a frame number to perform object tracking. In object tracking mode, the digital media player 110 only plays a second frame with the frame number next to a first frame, or plays the digital media file including all frames, and suspends playback of the digital media file and remains at the first and second frames for object tracking.

The position definition module 122 defines position data of an object in the frames of the digital media file via the player interface 111 when the digital media player 110 plays the digital media file. The path recording/generation module 123 records the position data defined by the position definition module 122, and time data of the frames, and generates an object tracking path of the object in the digital media file according to the position and time data after the object tracking is complete.

It should be noted that when the position definition module 122 defines the position data of the object, the shape determination module 124 determines shape data of the object. The shape determination module 124 performs image segmentation based on the position data as a reference point to obtain a rough shape of the object, and then use a polygon to close in the shape of the object to obtain the shape data. At this time, the path recording/generation module 123 further records the shape data and integrates it to the object tracking path.

In play and path adjustment mode, the digital media player 110 can simultaneously play the digital media file and the object tracking path in the player interface 111 according to the time, position and shape data. When the digital media file and the object tracking path play simultaneously, the path adjustment module 125 can adjust the object tracking path, and the path recording/generation module 123 further records and updates the adjusted object tracking path. Further, transformation module 123 transforms the object tracking path to a specific format according to the position, time and shape data, such as BIFS of MPEG-4, but is not limited thereto.

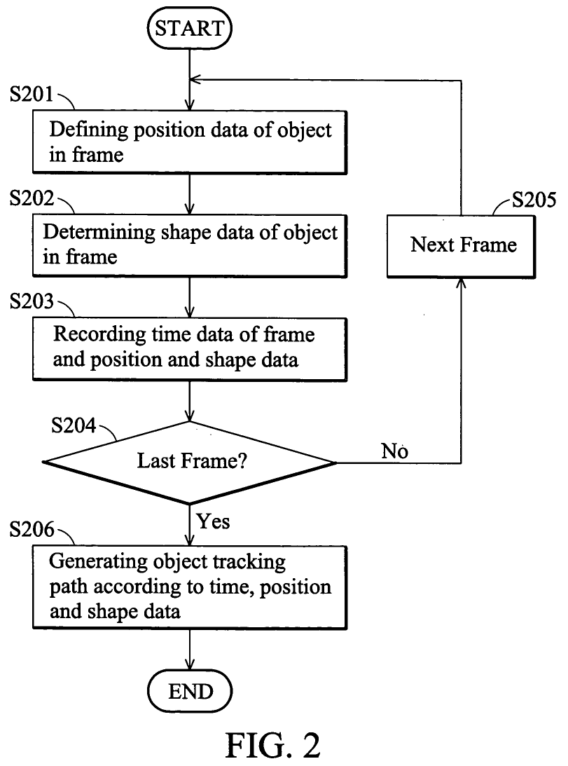

FIG. 2 shows the method for object tracking path generation according to the present invention.

First, in step S201, position data of an object in a frame of a digital media file is defined via the player interface during playback. Then, in step S202, image segmentation is performed using the position data as a reference point to obtain a rough shape of the object, and a polygon is used to close in the shape of the object to obtain the shape data. Then, in step S203, the time data of the frame, and the position and shape data is recorded.

Thereafter, in step S204, it is determined whether the current frame is the last frame of the digital media file. If not (No in step S204), in step S205, the digital media player plays the digital media file, stops at another frame, and steps S201 S204 of the procedure are repeated. It is noted that a frame interval can be predefined to perform object tracking. In object tracking mode, the digital media player will play and stay at frames according to the frame interval. If yes (Yes in step S204), in step S206, an object tracking path of the object in the digital media file is generated according to the time, position and shape data.

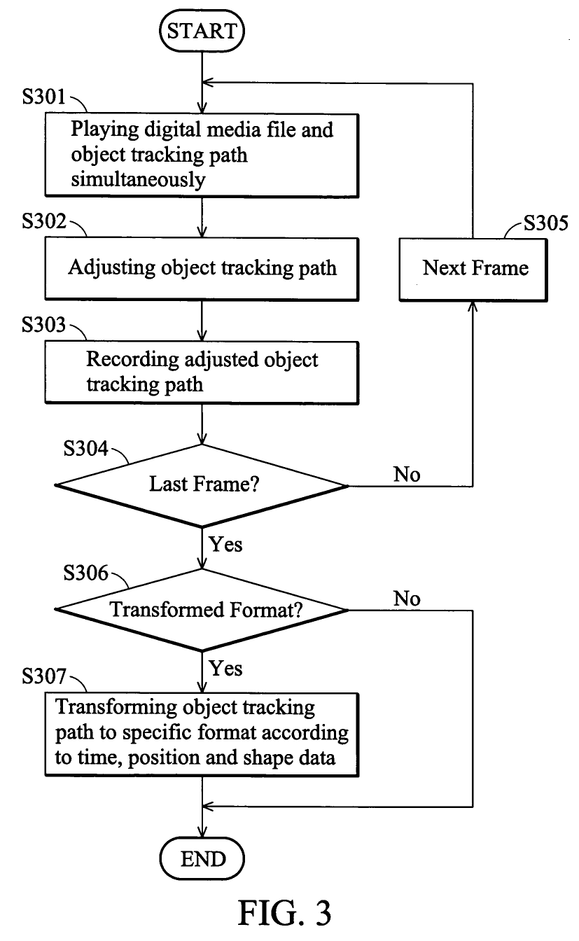

FIG. 3 shows the method for object tracking path adjustment and transformation according to the present invention.

First, in step S301, the digital media player simultaneously and synchronously plays the digital media file and the object tracking path according to the time, position and shape data. Then, in step S302, the object tracking path is adjusted via the player interface when the digital media file and the object tracking path are simultaneously played, and in step S303, the adjusted object tracking path is recorded and updated.

Thereafter, in step S304, it is determined whether the frame is the last frame of the digital media file. If not (No in step S304), in step S305, the digital media player plays the digital media file, stops at another frame, and steps S301˜S304 of the procedure are repeated. It is noted that all frames of the digital media file can be played in the player interface, but the object tracking path is only displayed on the frames conforming to the recorded time data. If yes (Yes in step S304), it means the adjustment is complete. Then, in step S306, it is determined whether a transformation is required. If no (No in step S306), the procedure is complete. If yes (Yes in step S306), in step S307, the object tracking path is transformed to a specific format according to the position, time and shape data.

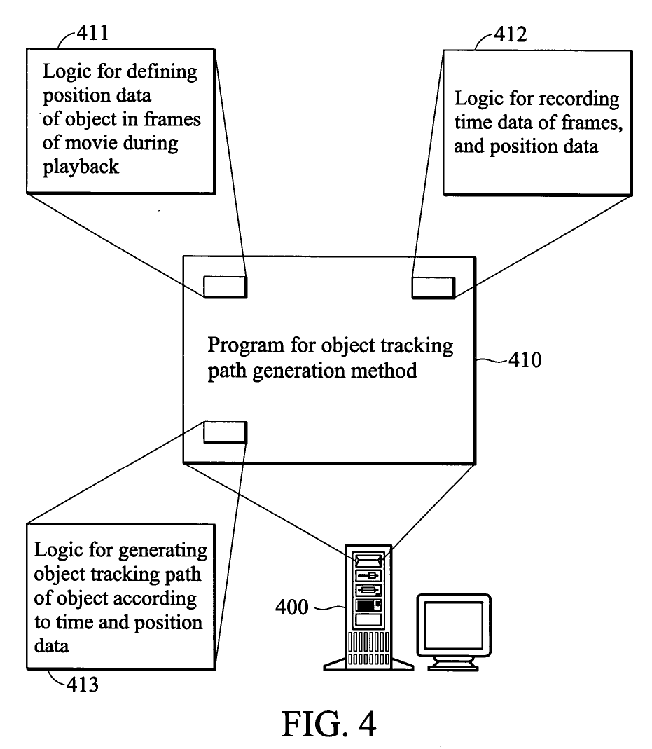

FIG. 4 is a diagram of a storage medium for storing a computer program providing the method for object tracking path generation according to the present invention. The computer program product comprises a storage medium 410 having computer readable program code embodied in the medium for use in a computer system 400, the computer readable program code comprises at least computer readable program code 411 for defining position data of an object in a plurality of frames of a digital media file via a player interface when the digital media file plays, computer readable program code 412 for recording time data of the frames and the position data, and computer readable program code 413 for generating an object tracking path of the object in the digital media file according to the time and position data.

The present invention thus provides a system and method for object tracking path generation integrating with a digital media player that automatically generates object tracking paths of objects in a digital media file played in the digital media player, and simultaneously adjusts the object tracking paths via the digital media player when the digital media file plays, thereby reducing required manpower for object tracking path generation, and increasing the accuracy of generated object tracking paths.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

1. A system for object tracking path generation, comprising:
a digital media player having a player interface for playing a digital media file having a plurality of frames; and
a tracking path processing unit, comprising:
a position definition module to define position data of an object in at least a first frame and a second frame of the frames via the player interface when the digital media player plays the digital media file; and
a path recording/generation module to record the position data defined by the position definition module, and time data of the first and second frames, and generate an object tracking path of the object in the digital media file according to the position and time data.

2. The system of claim 1 wherein the tracking path processing unit further comprises a frame interval definition module to define a frame number between the predetermined first and second frames.

3. The system of claim 1 wherein the tracking path processing unit further comprises a shape determination module to determine shape data of the object in the predetermined first and second frames.

4. The system of claim 3 wherein the path recording/generation module further records the shape data and integrates it to the object tracking path.

5. The system of claim 1 wherein the digital media player further simultaneously plays the digital media file and the object tracking path in the player interface according to the time and position data.

6. The system of claim 5 wherein the tracking path processing unit further comprises a path adjustment module to adjust the object tracking path when the digital media file and the object tracking path are simultaneously played in the player interface.

7. The system of claim 6 wherein the tracking path processing unit further comprises a transformation module to transform the object tracking path to a specific format according to the position and time data.

8. The system of claim 1 wherein the specific format comprises binary format for scene (BIFS).

9. A machine-readable storage medium storing a computer program which, when executed, directs a computer to perform a method of object tracking path generation, comprising the steps of:
playing a digital media file having a plurality of frames by a digital media player having a player interface;
defining position data of an object in at least a first frame and a second frame of the frames via the player interface when the digital media file plays;
recording the position data, and time data of the first and second frames; and
generating an object tracking path of the object in the digital media file according to the position and time data.

10. The storage medium of claim 9 further comprising defining a frame number between the predetermined first and second frames.

11. The storage medium of claim 9 further comprising determining shape data of the object in the predetermined first and second frames.

12. The storage medium of claim 11 further comprising recording the shape data and integrating it to the object tracking path.

13. The storage medium of claim 9 further comprising simultaneously playing the digital media file and the object tracking path in the player interface according to the time and position data.

14. The storage medium of claim 13 further comprising adjusting the object tracking path when the digital media file and the object tracking path are simultaneously played in the player interface.

15. The storage medium of claim 14 further comprising transforming the object tracking path to a specific format according to the position and time data.

16. The storage medium of claim 9 wherein the specific format comprises binary format for scene (BIFS).

17. A method for object tracking path generation, comprising the steps of:
defining position data of an object in a plurality of frames of a digital media file via a player interface when the digital media file plays;
recording time data of the frames and the position data; and
generating an object tracking path of the object in the digital media file according to the position and time data.

18. The method of claim 17 further comprising determining shape data of the object in the frames, and integrating the shape data to the object tracking path.

19. The method of claim 17 further comprising adjusting the object tracking path via the player interface when the digital media file and the object tracking path are simultaneously played.

20. The method of claim 18 further comprising transforming the object tracking path to a specific format according to the position, time and shape data.
